(19) United States
(12) Patent Application Publication
(10) Pub. No.: US 2006/0095316 A1
(43) Pub. Date: May 4, 2006

(54) Method and system for establishing a defined benefit plan

(76) Inventors: Jeffrey W. Stevenson, Prospect Heights, IL (US); Jeffrey J. Berends, Sedalia, CO (US); Christopher D. Kim, Littleton, CO (US); Peter R. Berg, San Francisco, CA (US); Christine Caldwell, Los Angeles, CA (US); Kay Fleischer, Chicago, IL (US); Trey Hickman, St. Paul, MN (US)

Correspondence Address: Douglas H. Pauley;Pauley Petersen & Erickson, Suite 365, 2800 West Higgins Road, Hoffman Estates, IL, 60195, US

(21) Appl. No.: 10/979,080

(22) Filed: Nov. 1, 2004

(51) Int. Cl. G06F 17/60

(52) U.S. Cl. 705/11

(57) ABSTRACT

A computer-implemented method of establishing and maintaining a defined benefit plan for a party. A user interface is associated with a computer system for requesting and receiving employment information from the party through the user interface. The computer system automatically determines an eligibility of the party for the defined benefit plan using the employment information. Demographic information and economic information from the party is requested and received through the user interface. The computer system automatically determines a current year maximum contribution for the defined benefit plan using the demographic information and the economic information. The computer system automatically structures the defined benefit plan from the current year maximum contribution for the party. The computer system automatically generates at least one application file for the defined benefit plan. The method and system of this invention provide for on-going, automated maintenance of the defined benefit plan through the user interface.

### FIELD OF THE INVENTION

This invention relates to a method for establishing a defined benefit plan and a system for implementing the method.

### BACKGROUND OF THE INVENTION

There are two general deferred compensation plans available for accumulating money for reasons such as retirement. Defined contribution plans, such as a 401(k) plan, allow an employee to save money by depositing into the plan a defined contribution, which is based solely on a percentage of the participant's current year earnings, subject to a maximum contribution limit. A defined benefit plan is designed to provide a party with a specific benefit at retirement. For a defined benefit plan, actuarial calculations are generally needed to determine annual contributions that are required to provide the benefit. The calculations typically take into account the party's age, years of service and average earnings over several years.

Depending on a party's age and compensation history, tax laws and regulations may allow the party to make relatively larger tax-deferred annual contributions to a defined benefit plan than to a defined contribution plan. However, establishing a defined benefit plan generally requires an experienced actuary to determine, based upon factors such as age and compensation, contribution limits for a particular party. Moreover, the party must contact the actuary each year when final compensation and/or profit amounts are known in order to determine the party's actual pension contribution for the year. In addition, the party must contact the actuary anytime the defined benefit plan needs to be revised, for example, upon the party wanting to alter the plan design. This subjects the party to the actuary's availability, and can result in the party experiencing delays in obtaining answers or updating plan information or account value information. Therefore, the party may undesirably wait for a response from the actuary, leaving the party with uncertainty about necessary upcoming financial and tax planning decisions. The delay is often particularly long toward an end of a business year, when the actuary is likely reviewing and updating year-end results for numerous defined benefit plans.

The above difficulties, and the resulting costs, in establishing and maintaining a defined benefit plan often keeps sole proprietors, including attorneys, accountants, board directors and small corporations from investigating and implementing defined benefit plans. Also, the lack of control that a party's financial advisor, e.g., accountant, financial planner, broker, etc., has over the process often keeps the advisor from recommending a defined benefit plan for a party.

There is a need for a simplified system for establishing and updating a defined benefit plan. There is a need for an automated system for establishing and updating a defined benefit plan without the need for individualized attention of, for example, an actuary. There is a need for a web-based system for convenient and automatic structuring, updating and/or restructuring of a defined benefit plan. There is a need for Internet-based access to updated account values to allow for updating and/or restructuring an existing defined benefit plan.

### SUMMARY OF THE INVENTION

A general object of this invention is to provide an improved method and system for establishing a defined benefit plan.

A more specific objective of this invention is to overcome one or more of the problems described above.

The general object of this invention can be attained, at least in part, through a computer-implemented method of establishing a defined benefit plan for a party. The method includes providing a user interface associated with a computer system, and requesting and receiving employment information from the party through the user interface. The computer system automatically determines an eligibility of the party for the defined benefit plan using the employment information. The method further includes requesting and receiving demographic information and economic information from the party through the user interface. The computer system automatically determines a current year maximum contribution for the defined benefit plan using the demographic information and the economic information. The computer system then automatically structures the defined benefit plan as a function of the current year maximum contribution for the party and, if any, additional inputs from the party regarding contribution objectives. Upon the party accepting the structure, the computer system automatically generates at least one application file for the defined benefit plan that enables the party to activate the defined benefit plan. Once the defined benefit plan is activated, the computer system allows for on-going maintenance and administration of the plan on an automated basis.

In contrast to this invention, the prior art generally fails to disclose an automated method and system for establishing, updating and maintaining a defined benefit plan at the convenience of a party. The prior art also fails to disclose an Internet-based method or system for establishing, updating and maintaining a defined benefit plan.

This invention provides a method of establishing a defined benefit plan for a party in real-time through a user interface associated with a computer system. The computer system structures the defined benefit plan from information inputted by the party, such as through the user interface. The computer system updates the contribution requirements in response to revised information inputted by the party through the user interface. The computer system allows for restructuring the defined benefit plan in response to revised objectives and/or information inputted by the party through the user interface. The computer system also can perform necessary and required on-going administrative functions for the party on an automated basis, such as preparing and filing government forms.

This invention also provides a method of updating a party's defined benefit plan using a user interface associated with a computer system. The computer system receives revised economic information through the user interface and the computer system automatically updates a revised current year contribution as a function of the revised economic information.

This invention further provides a method of automatically determining a contribution of a party for a defined benefit plan. A user interface associated with a computer system is provided for requesting and receiving information from the party. The information includes at least one of an age of the party, years of service, an estimated current year compensation and past annual compensation. The computer system automatically estimates a maximum level funding normal cost and/or a maximum unit credit normal cost. The computer system then automatically determines a current year maximum contribution as a higher one of the maximum level funding normal cost and the maximum unit credit normal cost.

This invention also provides a method of automatically determining a contribution of a party for a defined benefit plan. A user interface associated with a computer system is provided for requesting and receiving information from the party through the user interface. The information includes at least an age of the party, years of service, an estimated current year compensation and past annual compensation. The computer system automatically calculates an average compensation of the party as a function of the past annual compensation. The computer system automatically determines a maximum projected benefit of the party at each of a plurality of assumed retirement ages and a projected accumulation at each of the plurality of assumed retirement ages as a function of the maximum projected benefit and a predetermined rate of investment return The computer system automatically estimates for each of the plurality of assumed retirement ages a level funding normal cost as a function of the projected accumulation at the assumed retirement age to obtain a plurality of estimated level funding normal costs. The computer system automatically selects a maximum level funding normal cost from the plurality of estimated level funding normal costs. The computer system also automatically determines a maximum current year benefit accrual of the party at each of the plurality of assumed retirement ages and a projected accumulation at each of the plurality of assumed retirement ages as a function of the maximum current year benefit accrual, a predetermined life expectancy and a predetermined rate of investment return. The computer system automatically estimates for each of the plurality of assumed retirement ages a unit credit normal cost as a function of the projected accumulation to obtain a plurality of estimated unit credit normal costs. The computer system automatically selects a maximum unit credit normal cost from the plurality of estimated unit credit normal costs and determines a current year maximum contribution as a higher one of the maximum level funding normal cost and the maximum unit credit normal cost.

This invention further provides a method of determining a contribution for restructuring a defined benefit plan of a party. A user interface associated with a computer system is provided. The computer system retrieves from a database information including at least one of an age of the party, years of service and past annual compensation. The computer system desirably also receives an updated or revised estimated or final current year compensation from the party through the user interface (if this information is not already in the database). The computer system receives an account value for the defined benefit plan from an asset administrator. The computer system then automatically estimates a maximum level funding normal cost as a function of the information and the account value. The computer system automatically estimates a maximum unit credit normal cost as a function of the information and the account value. The computer system automatically determines a current year maximum contribution as a higher one of the maximum level funding normal cost and the maximum unit credit normal cost.

This invention still further provides a computer readable medium containing code for controlling a computer to perform the steps of: providing a web site; displaying a series of questions on the web site; storing information inputted through the web site in response to the series of questions; determining an eligibility for a defined benefit plan using the information inputted on the web site; determining and displaying on the web site a current year maximum contribution for the defined benefit plan; displaying on the web site optional alternative target annual contributions; receiving through the web site a selected target annual contribution; and generating at least one application file for the defined benefit plan, the application file including at least one enrollment document; and displaying the at least one enrollment document on the web site.

This invention provides a system for establishing a defined benefit plan of an administrator. The system includes a domain server and a computer controlled by an administrator of the defined benefit plan. The computer and the domain server are interconnected and have software applications for providing functionalities including: a party intake functionality for entering at least one of employment information, demographic information and economic information of the party and maintaining a database of the employment information, demographic information and/or economic information; an eligibility determination functionality for providing the party with information regarding an eligibility of the party for the defined benefit plan; a contribution determination functionality for determining a current year maximum contribution and receiving a target annual contribution selected by the party; and an application file generation functionality for generating and displaying at least one enrollment document on the web site for enabling the party to print the enrollment document for return to the administrator. The is functionalities are available to the party automatically through a web site operated by the domain server.

As used in this specification and the claims, references to a “defined contribution plan” are to be understood to refer to a retirement plan that provides for an individual account for each participating party and the benefit is based solely on the amount, and any income, expense, gains and/or losses, that are allocated to the party's account.

As used in this specification and the claims, references to a “defined benefit plan” are to be understood to refer to a plan that provides for a specified retirement benefit as of a specified retirement date. In other words, the benefit is defined, not the amount that must be contributed. The contribution is generally determined according to governing tax laws and/or regulations.

Further, as used in this specification and the claims, references to “compensation” are to be understood to include either a net profit or a minimum salary plus, if any, an estimated additional profit for a particular business year, depending on the party's business and/or compensation structure. “Net profit” generally refers to a party's gross business income minus business expenses, such as is reported in the United States on IRS Form 1040 Schedule C. “Gross wages” generally refers to the gross pay listed on a party's IRS Form W2.

Other objects and advantages will be apparent to those skilled in the art from the following detailed description taken in conjunction with the appended claims and drawings.

### BRIEF DESCRIPTION OF THE DRAWINGS

FIG. 1 is a flow diagram of a method of establishing a defined benefit plan according to one embodiment of this invention.

FIG. 2 is a flow diagram of a method of determining a contribution of a party for a defined benefit plan according to one embodiment of the invention.

FIG. 3 is a block diagram showing a system for establishing, updating and maintaining a defined benefit plan of an administrator, according to one embodiment of this invention.

### DETAILED DESCRIPTION OF THE PRESENTLY PREFERRED EMBODIMENTS

This invention includes a computer system-implemented method for establishing, updating and/or restructuring a defined benefit plan. The method of this invention allows for online set-up and maintenance of a defined benefit plan in real-time by a party through the Internet. The method of this invention reduces or eliminates many, if not all, of the problems and inconveniences discussed above that are typical in a manual administration of such plans.

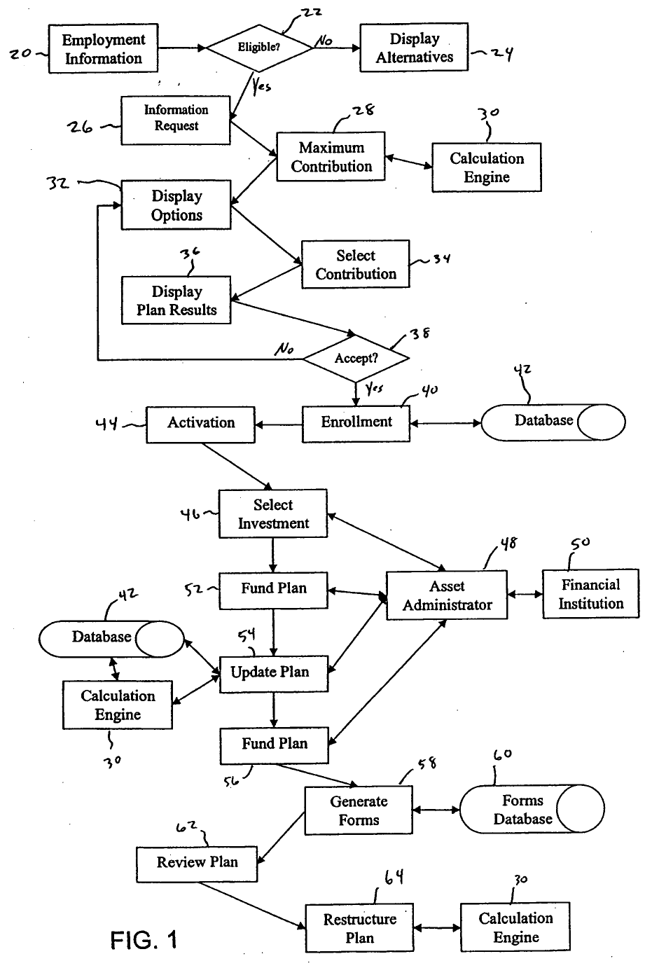

FIG. 1 is a flow diagram of a method of establishing a defined benefit plan according to one embodiment of this invention. The method illustrated in FIG. 1 is performed through a user interface provided by, i.e., sponsored, controlled and/or maintained by, an administrator of the defined benefit plan. As used in this specification and in the claims, an “administrator of the defined benefit plan” refers generally to a party, a company or an organization that offers or provides services relating to establishing and maintaining defined benefit plans, such as, for example and without limitation, an actuary or a company operating in the field of employee benefits. In one particularly preferred embodiment of this invention, the user interface is a web site. While this invention is described below with reference to a web site as the user interface, one skilled in the art will appreciate that this invention is not intended to be so limited. The user interface can be any electronic system, apparatus or other package for implementing the method of this invention with a computer. For example, in one embodiment of this invention, the user interface includes a CD-ROM disc containing software for loading onto a party's computer and implementing at least a portion of the method of this invention.

The user interface, or a web site, is associated with a computer system, and more particularly a computer system including a domain server for operating the web site. Referring to FIG. 1, in step 20, the web site requests the viewing party, or the party's representative, who has accessed the web site and is interested in establishing or seeking to establish a defined benefit plan for the party, to enter at least employment information. In one particularly preferred embodiment of this invention, “employment information” refers to at least information regarding the number of employees of the party. Other employment information that may be collected for any or a particular party, either in step 20 or in a later step, includes when the party was established, e.g., when the party first started the business or was organized or incorporated, and/or information about any defined benefit plan assets owned by the party.

The computer system receives the employment information entered by the party through the web site. In step 22, the computer system automatically determines an eligibility of the party for the defined benefit plan using the provided employment information. In one embodiment of this invention, the party is eligible for the defined benefit plan if the party, for example, is a sole proprietor or the sole employee of a corporation or other organized company owning or controlling no other company or business organization having another employee. The computer system may automatically display the eligibility determination on the web site. If the party is ineligible for the defined benefit plan, the computer system can inform the party, such as through the web site, and, in step 24, displays links to, or information regarding, other deferred compensation or investment opportunities of interest.

For an eligible party, in step 26 the computer system requests additional information from the party through the web site. In one embodiment of this invention, the computer system, through one or more linked web site pages, requests demographic information and economic information from the party. The “demographic information” collected in step 26 includes at least information regarding the age of the party. Other demographic information that may be collected, either in step 26 or in a later step, includes the party's marital status, the party's full name, address, and/or other personal information. The “economic information” collected in step 26 includes at least information about the party's compensation. In one embodiment of this invention, the economic information includes at least one of the party's past annual compensation for each of at least one of the previous three consecutive business years and either an estimated or final current year compensation. As will be appreciated by those skilled in the art, other information, such as the additional employment information discussed above, can also be requested and received in step 26.

In step 28, the computer system automatically determines a current year maximum contribution for the defined benefit plan using the demographic information and the economic information. The current year maximum contribution is the maximum amount the party may contribute or deposit into the defined benefit plan under the governing tax or other laws and/or regulations. A calculation engine 30 of the computer system determines the current year maximum contribution automatically. The calculation engine 30 can include one or more series of software codes for calculating the current year maximum contribution from the information entered by the party, e.g., the party's age, past annual compensation and/or estimated or final current year compensation. As will be appreciated by those skilled in the art following the teachings of this invention, in one embodiment of this invention the current year maximum contribution is estimated from economic information inputted by the party, such as discussed above. As will also be appreciated by those skilled in the art, the calculation engine 30 performs calculations under governing tax laws and/or regulations that are otherwise performed manually, such as by, for example, an actuary.

In one embodiment of this invention, the computer automatically structures the defined benefit plan from the current year maximum contribution for the party. Referring to FIG. 1, in step 32, the computer system displays through the web site the current year maximum contribution and options for a target annual contribution. Alternative target annual contributions are displayed on the web site for the party with a request for the party to select one target annual contribution from the list of optional alternative target annual contributions.

In one embodiment of this invention, the alternative target annual contributions for an unincorporated sole proprietor are or include at least one of: 1) a fixed amount equal to the current year maximum contribution; 2) a fixed amount less than the current year maximum contribution; 3) a maximum allowable annual contribution, i.e., the highest amount possible for each business year; 4) a fixed percentage of an annual adjusted net profit of the party; and 5) a fixed percentage of an annual adjusted net profit of the party subject to an annual dollar maximum. When the party is the sole employee of a corporation, or similarly organized entity, where a salary is paid to the party, the alternative target annual contributions are or include at least one of: 1) a fixed amount equal to the current year maximum contribution; 2) a fixed amount less than the current year maximum contribution; 3) a maximum allowable annual contribution; 4) a fixed percentage of annual gross wages of the party; and 5) a fixed percentage of annual gross wages of the party subject to an annual dollar maximum.

The party selects one of the displayed alternative target annual contributions in step 34. The computer system receives the selected target annual contribution and, in step 36, automatically structures the defined benefit plan based upon the target annual contribution. The computer system then displays the structured defined benefit plan information. In one embodiment of this invention, the computer system additionally estimates an asset accumulation. The asset accumulation is estimated as a function of the target annual contribution and, desirably, an assumed investment return rate. The asset accumulation is displayed through the web site, desirably with the details of the defined benefit plan, and in a table showing a schedule of the asset accumulation according to a predetermined number of years and on a per-year basis.

In one embodiment of this invention, in step 38, the party has an opportunity to either accept the displayed defined benefit plan or repeat steps 32 through 36 to restructure the defined benefit plan. If the party chooses to restructure the defined benefit plan, the party returns to the web site page displaying the alternative target annual contributions and has the opportunity to select one of the other alternative target annual contributions. The party makes the different selection in step 34 and computer system receives the newly selected target annual contributions and, in step 36, automatically restructures the defined benefit plan based upon the newly selected target annual contribution and desirably using the calculation engine 30.

The method of this invention provides the party with the ability to restructure the defined benefit plan to view alternative results before finally selecting or establishing the defined benefit plan. The party may repeat steps 32 through 36 as many times as desired until the party obtains a defined benefit plan that fits the party's need. When the party is ready to finish the process and enroll in or structure the defined benefit plan, the party finally selects the defined benefit plan of choice. In one embodiment of this invention, by approving or selecting the defined benefit plan the party requests application files be generated for the defined benefit plan by clicking or selecting a provided button or link. In step 40, the computer system requests any additional information needed for enrollment documents and stores all the entered information and the details on the defined benefit plan in a database 42.

In step 40, the computer system also automatically generates at least one application file for the party and/or the defined benefit plan. As used in this specification and in the claims, references to an “application file” refer to one or more files including at least one of enrollment information and/or one or more electronic enrollment documents. Examples of enrollment documents include a plan adoption agreement form, a document including the terms and conditions of the defined benefit plan, a beneficiary designation form, a service agreement, and/or a fee schedule. The computer system displays the at least one enrollment form, which desirably includes a signature form, through the web site for the party to print and execute. The party can print, execute any signature forms and return the signature forms to the appropriate entity, such as the administrator of the defined benefit plan. As will be appreciated by those skilled in the art following the teachings of this invention, alternative procedures for executing the necessary enrollment forms according to the method of this invention include, for example, an electronic signature execution submitted through the web site. In step 44, the administrator of the defined benefit plan receives the executed enrollment forms and activates or finalizes the defined benefit plan. The administrator also establishes and activates an asset account for the party. The asset account may be held and/or maintained by the administrator or a third party asset administrator or financial institution. The asset account is desirably linked to the computer system and account information, including an account value, is desirably available for viewing by the party through the user interface.

This invention thus provides an automated, computer-implemented method and system for establishing or structuring a defined benefit plan. The method of this invention, as illustrated in FIG. 1, allows the party to establish and view various available options in real-time through the web site at the party's convenience by removing the need for personalized attention from, for example, an actuary. The method of this invention provides the party with enhanced flexibility, immediate response and control over the defined benefit plan structuring process.

In addition, the method and systems of this invention provide the party with the ability to access the defined benefit plan for online viewing and control of the assets of the defined benefit plan. In one embodiment of this invention, the party can view account information and choose or change investment options for the defined benefit plan by coded access through the web site. Referring to FIG. 1, the party has the ability through the web site in step 46, to select from various investment opportunities available for the defined benefit plan. The investment opportunities may be available through the administrator of the defined benefit plan, a related company of the administrator or one or more third party financial institutions, such as, for example, brokers, mutual fund companies and/or banks. In one embodiment of this invention, illustrated in FIG. 1, the offering and/or selection of available investment opportunities is performed through an independent, third party asset administrator 48, either through the web site or a linked web site of the asset administrator 48.

In one embodiment of this invention, the party has access through the web site to another web site maintained by the asset administrator 48. In this embodiment, the computer system of the administrator of the defined benefit plan is associated with a computer system of the asset administrator 48. The computer system of the asset administrator 48 can be further associated with a computer system of a financial institution 50. The party can select one or more investment vehicles, such as a mutual fund, in step 46 and funds the defined benefit plan in step 52. The defined benefit plan can be funded by methods known and available in the art, such as, for example, electronic fund transfer through the web site.

In one embodiment of this invention, in addition to initially selecting or electing investment opportunities, the party can view updated account values and change investment elections online through the web site. The computer system, either the computer system of the asset administrator 48 or the computer system of the administrator of the defined benefit plan, receives and stores an updated account value for the defined benefit plan. In one embodiment of this invention, the computer system receives updated account information upon request by the party, such as a request made through the web site. The updated account value is reported to the party through the web site. The party has coded, i.e., password protected, access to the web site and can view the updated account value at the convenience of the party. In addition, in view of changes in account value due to investment, the party can determine and update a current year contribution that is needed for the current business year. In other words, and as will be appreciated by those skilled in the art, the amount of contributions by the party for the current business year are influenced by and may need to be adjusted as a function of the updated account value which may fluctuate due to market conditions. Desirably, the computer system receives and stores the updated account value at defined time intervals, for example, and desirably, at the end of every business day.

The updated account value is received from one or more financial institutions 50 holding account assets of the defined benefit plan. As illustrated in FIG. 1, the updated account assets are reported by the asset administrator 48. However, as will be appreciated by those skilled in the art following the teachings of this invention, various and alternative methods for receiving and reporting updated account values are available for use in the method of this invention. For example, in one embodiment of this invention where there is no independent third party asset administrator 48, the computer system of the administrator of the defined benefit plan receives the updated account information directly from the one or more financial institutions and reports the updated account information to the party through the web site.

In one embodiment of this invention, the party is able to update the defined benefit plan through the website. The defined benefit plan is updated as a function of revised information from the party, such as at least one of revised economic information, revised demographic information and/or the updated account value of the party. Referring to FIG. 1, in step 54 the computer system receives at least one of the revised economic information and the revised demographic information. As discussed above, the computer system may also receive an updated account value from the one or more financial institutions 50 through the asset administrator 48, such as upon a request from the party for completing the update and/or restructuring the defined benefit plan.

In one embodiment of this invention the revised economic information includes a final current year compensation. As discussed above for steps 26 through 38, the defined benefit plan may be initially established using estimated information, particularly estimated economic information. In other words, the party may enter through the web site in step 26 an estimated current year compensation. The estimated current year contribution can also be updated by the party at any time before a business year end by entering an updated or revised estimated current year compensation through the web site as revised economic information. At, after, or near the end of the current business year in which the defined benefit plan is established, the party can update the estimated economic information with final, actual revised economic information. From the revised economic information, revised demographic information and/or the updated account value, if any, the computer system automatically determines an actual current year contribution, i.e., a current year funding requirement. The computer system additionally utilizes the calculation engine 30 and information stored in the database 42 to calculate the final, actual current year contribution. The party receives the actual current year contribution through the website. In step 56, the party funds the defined benefit plan with an amount necessary to meet the actual current year contribution. The funding of step 56 can be done without the need to contact an actuary, thereby reducing or eliminating the typical delays discussed above.

In step 58, the computer system desirably automatically generates at least one additional form, such as the necessary government reporting forms, for example IRS Form 5500. Generation of the Form 5500 desirably occurs upon the system knowing the appropriate contribution has been made to the defined benefit plan account for the current plan year, and/or based upon other stored information. In one embodiment of this invention, the party can authorize the administrator and/or computer system to automatically prepare and file, for example electronically, the Form 5500 with the Internal Revenue Service, with a copy delivered, for example electronically, to the party and a copy stored within the computer system and available for viewing on the user interface. The computer system desirably generates the at least one additional form using information stored in a form database 60.

In step 62, the party can review defined benefit plan information. The party has coded access through the web site to review defined benefit plan information at the convenience of the party, such as before, at or after the end of a current business year. In addition, the party, in step 64, has the ability through the web site to restructure or amend the defined benefit plan according to changes in economic information, demographic information and/or employment information at any time during the initial business year or during any subsequent business year. In one embodiment of this invention, the party can determine whether an amendment to the defined benefit plan is desired by restructuring the defined benefit plan automatically through the web site, such as by repeating steps 26 through 38. If the party chooses to amend the defined benefit plan the computer system automatically generates and displays through the web site the necessary amendment documents, such as an amended adoption agreement, for printing and, if necessary, execution by the party. As will be appreciated by those skilled in the art following the teachings of this invention, the party may only amend the defined benefit plan in accordance with tax and other laws and regulations. Desirably, the computer system stores any and all changes to the party's defined benefit plan and informs the party whether the desired amended defined benefit plan is available under the law or otherwise advisable.

As discussed above, the method and system of this invention provide a party real-time access for establishing, updating and/or restructuring a defined benefit plan, as well as for viewing updated account information and managing the party's defined benefit plan. In addition, the method and system of this invention provide for improved marketing and client support. In one embodiment of this invention, the method and system for establishing a defined benefit plan are marketed through a plurality of independent sales agents, such as financial planners and financial institutions, for example mutual fund companies. The sales agents introduce and assist the party in proceeding through steps of the method using the web site. In addition, the sales agent can be given coded access to review any and/or all defined benefit plans and account values for any and/or all of the agent's clients.

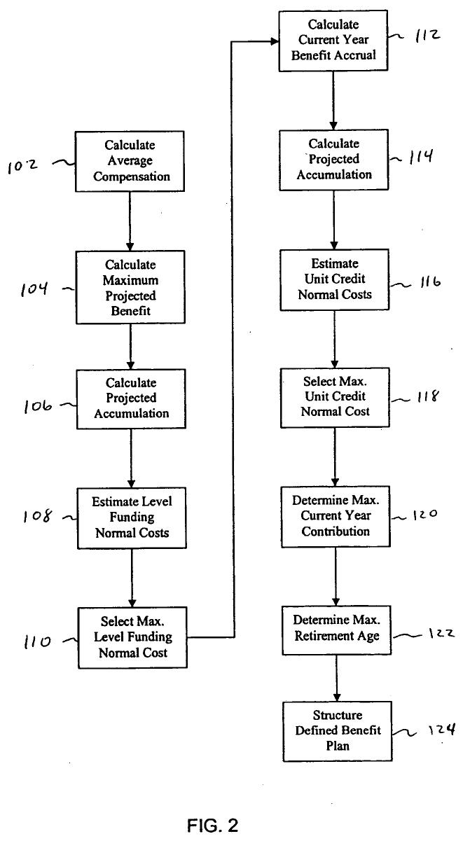

FIG. 2 illustrates a method of automatically determining a contribution of a party for a defined benefit plan according to one embodiment of the invention. The calculation engine 30 desirably performs the method illustrated in FIG. 2, such as in steps 28 or 64 described above and illustrated in FIG. 1.

The calculation engine 30 performs the method illustrated in FIG. 2 using information received from the party, such as the information received in step 20 and/or step 26 of FIG. 1. In one embodiment of this invention, the received information includes at least one of an age of the party, a number of years of service, an estimated current year compensation, and past annual compensation. In one embodiment of this invention, the computer system, through the web site, requests the party to input the party's date of birth and the first day of service, and the computer automatically calculates the party's age and years of service.

The computer system desirably requests the party enter the party's annual compensation for as many past years as possible, and more desirably at least the last three consecutive business years, if possible. If, for example, the party only has two years of service, then the party enters the party's annual compensation for the past two business years. If the current year is the party's first year of service, then the party will only enter the party's estimated current year compensation. In step 102, the computer system automatically calculates an average compensation of the party as a function of the inputted past annual compensation. In one embodiment of the invention, the computer system receives past annual compensation information for more than the last three years, the computer system automatically determines the three consecutive years providing the highest total compensation and calculates a high average compensation of the party from those three highest past annual compensations.

In step 104, the computer system automatically determines a maximum projected benefit of the party at each of a plurality of assumed retirement ages. In one embodiment of this invention, the lowest assumed retirement age is the higher of fifty-five years or the age of the party after five years of participation in the defined benefit plan. The computer calculates the maximum projected benefit for the lowest assumed retirement age and repeats the calculation for each subsequent assumed retirement age through a predetermined highest assumed retirement age. An example of a desirable highest assumed retirement age is the higher of sixty-five years or the age of the party after five years of participation in the plan. Step 106 includes an iterative process by which the computer system automatically calculates a projected accumulation at each of the plurality of assumed retirement ages. Each projected accumulation is a function of the respective maximum projected benefit, a predetermined life expectancy and a predetermined rate of investment return.

In step 108, the computer system automatically estimates for each of the plurality of assumed retirement ages a level funding normal cost. The level funding normal cost is the annual amount required at the end of each business year until the assumed retirement age to fund a lump sum retirement benefit for the party. The level funding normal cost is determined as a function of the projected accumulation at the respective assumed retirement age to obtain a plurality of estimated level funding normal costs. In step 110, the computer system automatically selects a maximum level funding normal cost from the plurality of estimated level funding normal costs.

Upon determining the maximum level funding normal cost the computer system automatically determines a maximum unit credit normal cost for comparison. To determine the maximum unit credit normal cost the computer system, in step 112, automatically determines a maximum current year benefit accrual for the party at each of the plurality of assumed retirement ages. The computer system calculates the maximum current year benefit accrual for the lowest assumed retirement age and repeats the calculation for each subsequent assumed retirement age through the highest assumed retirement age. Step 114 includes an iterative process by which the computer system automatically calculates a projected accumulation at each of the plurality of assumed retirement ages. Each projected accumulation is a function of the respective maximum current year benefit accrual, a predetermined life expectancy and a predetermined rate of investment return.

In step 116, the computer system automatically estimates for each of the plurality of assumed retirement ages a unit credit normal cost as a function of the respective projected accumulation from step 114. The unit credit normal cost is the actuarial equivalent at the end of the respective business year of the increase in accrued benefit during the business year, including amounts due to increases in applicable funding limits, such as are provided under Internal Revenue Code Section 415, on the party's accrued benefit. The computer system thus calculates a plurality of estimated unit credit normal costs; one for each assumed retirement age. In step 118, the computer system automatically selects a maximum unit credit normal cost from the plurality of estimated unit credit normal costs.

In step 120, the computer system compares the maximum level funding normal cost and the maximum unit credit normal cost. The computer system determines a current year maximum contribution to be the higher value between the maximum level funding normal cost and the maximum unit credit normal cost. The computer system displays the current year maximum contribution to the party through the web site.

As discussed above with reference to step 32 in FIG. 1, the computer system desirably displays on the web site options for a target annual contribution. The options are displayed in addition to displaying the current year maximum contribution. The computer system receives through the web site the target annual contribution inputted by the party and automatically structures a defined benefit plan from the target annual contribution. Referring to FIG. 2, in step 122, the computer system compares the target annual contribution to at least one of the plurality of estimated level funding normal costs and the plurality of estimated unit credit normal costs. The computer system desirably at least temporarily saves the plurality of estimated level funding normal costs and the plurality of estimated unit credit normal costs, determined above in steps 108 and 116, for use in step 122. The computer system looks to the plurality of estimated level funding normal costs to find the lowest normal cost which is still greater than the target annual contribution. The computer system then desirably adjusts the benefit associated with the selected normal cost to a level which produces the target level contribution. In one particularly preferred embodiment of this invention, the computer system firsts compares the target annual contribution to the plurality of estimated level funding normal costs to find an optimal retirement age, e.g., a maximum retirement age. If the desired lowest normal cost is not found among the level funding normal costs, the computer system looks to the plurality of estimated unit credit normal costs for an optimal retirement age, e.g., an earliest assumed retirement age.

In step 124, the computer system structures the defined benefit plan using the target annual contribution and the optimal retirement age. As discussed above with reference to step 38 in FIG. 1, the party is given the opportunity to either accept the structured benefit plan or repeat steps 32 to 36 to restructure the defined benefit plan using a different target annual contribution until the desired or optimal defined benefit plan is obtained. When the party chooses to enter a different target annual contribution, the computer system repeats step 122 of FIG. 2 using the new target annual contribution to determine the corresponding optimal retirement age. The computer system then structures in step 124, a new defined benefit plan using the new target annual contribution and the new optimal retirement age.

In one embodiment of this invention, the calculation engine 30 also performs necessary calculations to update the defined benefit plan, such as is performed in step 54 of FIG. 1. The defined benefit plan may be updated at the convenience of the party through the website. In one embodiment of this invention, the party updates the defined benefit plan upon obtaining revised information, for example revised economic information such as a revised current year compensation. The revised current year compensation could be an updated or revised estimated current year compensation, such as in a situation before the end of the year where the party realizes the party's compensation will likely be higher than previously expected, or a final current year compensation, such as will be determined at the end of each business year. The computer system automatically determines a revised current year contribution as a function of the revised current year compensation. If the party has already deposited funds into the defined benefit plan before inputting a revised current year compensation, the computer system receives the defined benefit plan account value for the party and determines the revised current year contribution as a function of the revised current year compensation and the account value.

In one embodiment of this invention, the calculation engine 30 desirably also determines a contribution for or during restructuring a party's defined benefit plan. As discussed above, the party has the ability to restructure the defined benefit plan by using an automated method also provided and accessed through the web site. Such restructuring typically occurs in a subsequent business year from the initial defined benefit plan establishment year. For restructuring the defined benefit plan, the computer system desirably retrieves the party's previous inputted information including at least one of an age of the party, years of service and past annual compensation from a database, such as database 42 in FIG. 1. The computer system also automatically obtains an updated account value for the defined benefit plan from the asset administrator. The computer system, through a process similar to the method illustrated in FIG. 2, automatically estimates a new or updated maximum level funding normal cost and an updated maximum unit credit normal cost as a function of the information and the account value. The computer system automatically determines an updated current year contribution as a higher one of the updated maximum level funding and unit credit normal costs.

Another embodiment of this invention is a computer readable medium, for example a disk, CD-ROM or computer hard drive, containing code for controlling a computer to implement the method of this invention. The medium includes code for providing a web site that displays a series of questions. The information inputted through the web site in response to the questions is stored by the computer. The code causes the computer to automatically determine an eligibility for a defined benefit plan using the information inputted on the web site. The medium also contains code to determine and display on the web site a current year maximum contribution for the defined benefit plan and displaying on the web site optional alternative target annual contributions. The computer receives a selected target annual contribution through the web site and generates at least one application file for the defined benefit plan. The application file desirably includes at least one enrollment document that can be displayed on and printed from the web site. Desirably, the medium also contains code to allow for the on-going maintenance of, updating of and/or restructuring of the defined benefit plan through the user interface discussed above.

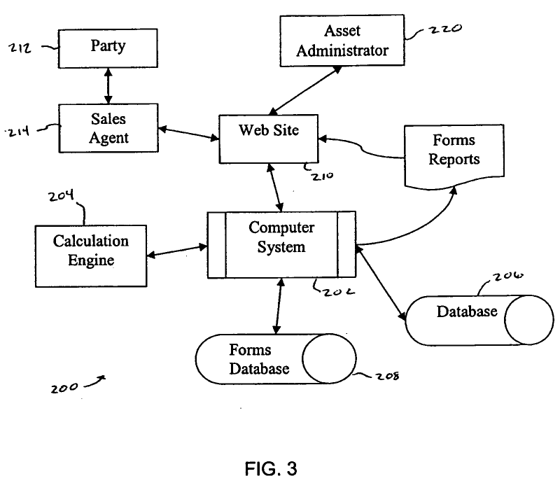

FIG. 3 illustrates a system 200 for establishing, updating and/or maintaining a defined benefit plan of an administrator. The system 200 includes a computer system 202 controlled by the administrator. The computer system 202 includes a domain server and a computer. The computer and the domain server are interconnected and have software applications for providing particular functionalities. The computer system 202 includes at least one calculation engine 204 for performing one or more of the calculations described above, a party information database 206 and a forms database 208. The computer system 202 establishes and maintains a website 210. A party 212, through a computer and/or domain server of a sales agent 214, accesses the web site 210 through an Internet connection 216. An asset administrator 220 associated with the administrator of the defined benefit plan also has access to the web site 210 by an Internet connection 222.

The computer system 202 provides a party intake functionality for entering at least one of employment information, demographic information and economic information of the party through the web site 210. The computer system stores the entered information in the party information database 206. The computer system 202 has an eligibility determination functionality for providing the party 212 with information regarding the party's eligibility for the defined benefit plan. The computer system 202 further includes a contribution determination functionality for determining a current year maximum contribution and receiving a target annual contribution selected by the party 212 through the web site 210. The eligibility determination functionality and the contribution determination functionality are desirably performed by the calculation engine 204, such as by using information from the party information database 206. The computer system 202 further includes an application file generation functionality for generating and displaying at least one enrollment document on the web site for enabling the party 212 to print the enrollment document for return to the administrator of the defined benefit plan. The computer system 202 desirably accesses the forms database 208 for generating the at least one enrollment form.

Thus this invention provides a method and system for establishing a defined benefit plan over the Internet. The method of this invention provides real-time access at the convenience of a party to establish and update a defined benefit plan, without requiring the party to contact and be subject to the schedule of, for example, an actuary. In addition, the party is given coded web site access of the defined benefit plan accounts for reviewing updated account information, changing investment elections based upon regularly updated account values and/or investment performance, receiving updated contribution amounts based upon revised or updated economic and/or demographic information, and the ability to restructure the defined benefit plan. The method and system of this invention provide for on-going maintenance functionality that is required by the defined benefit plan.

While the embodiments of this invention described are presently preferred, various modifications and improvements can be made without departing from the spirit and scope of this invention. The scope of this invention is indicated by the appended claims, and all changes that fall within the meaning and range of equivalents are intended to be included.

What is claimed is:

1. A method of automatically determining a contribution of a party for a defined benefit plan, the method comprising:
providing a user interface associated with a computer system;
requesting and receiving information from the party through the user interface, the information including at least one of an age of the party, years of service, an estimated current year compensation and past annual compensation;
the computer system automatically estimating at least one of a maximum level funding normal cost and a maximum unit credit normal cost; and
the computer system automatically determining a current year maximum contribution as a function of the at least one of the maximum level funding normal cost and the maximum unit credit normal cost.

2. The method according to claim 1, wherein the current year maximum contribution is a higher one of the maximum level funding normal cost and the maximum unit credit normal cost

3. The method according to claim 2, further comprising the computer system automatically calculating an average compensation of the party as a function of the past annual compensation.

4. The method according to claim 3, wherein the average compensation comprises a high average compensation of past annual compensation up to three consecutive years.

5. The method according to claim 3, wherein automatically estimating the maximum level funding normal cost comprises:
automatically determining a maximum projected benefit of the party at an assumed retirement age;
automatically calculating a projected accumulation at the assumed retirement age as a function of the maximum projected benefit, a predetermined life expectancy and a predetermined rate of investment return; and
automatically estimating a level funding normal cost as a function of the projected accumulation at the assumed retirement age.

6. The method according to claim 5, further comprising:
automatically estimating the level funding normal cost for each of a plurality of assumed retirement ages to obtain a plurality of estimated level funding normal costs; and
automatically selecting the maximum level funding normal cost from the plurality of estimated level funding normal costs.

7. The method according to claim 5, wherein determining a maximum projected benefit of the party at an assumed retirement age comprises an iterative calculation.

8. The method according to claim 5, wherein automatically estimating the maximum unit credit normal cost comprises:
automatically determining a maximum current year benefit accrual of the party at an assumed retirement age;
automatically calculating a projected accumulation at the assumed retirement age as a function of the maximum current year benefit accrual, a predetermined life expectancy and a predetermined rate of investment return; and
automatically estimating a unit credit normal cost as a function of the projected accumulation at the assumed retirement age.

9. The method according to claim 8, further comprising:
automatically estimating the unit credit normal cost for each of a plurality of assumed retirement ages to obtain a plurality of estimated unit credit normal costs; and
automatically selecting the maximum unit credit normal cost from the plurality of estimated unit credit normal costs.

10. The method according to claim 8, wherein determining a maximum current year benefit accrual of the party at an assumed retirement age comprises an iterative calculation.

11. The method according to claim 8, further comprising:
displaying through the user interface the current year maximum contribution for the party; and
requesting and receiving through the user interface at least one target annual contribution from the party; and
automatically determining an optimal retirement age for the at least one target annual contribution.

12. The method according to claim 1, further comprising:
receiving a revised current year compensation from the party through the user interface; and
the computer system automatically determining a revised current year contribution as a function of the revised current year compensation.

13. The method according to claim 12, further comprising receiving an account value from an asset administrator, wherein the computer system automatically determines the revised current year contribution as a function of the revised current year compensation and the account value.

14. The method according to claim 1, wherein the user interface comprises a web site.

15. A computer readable medium containing code for performing the method of claim 1.

16. A method of automatically determining a contribution of a party for a defined benefit plan, the method comprising:
providing a user interface associated with a computer system;
requesting and receiving information from the party through the user interface, the information including at least an age of the party, years of service, an estimated current year compensation, and past annual compensation;
the computer system automatically calculating an average compensation of the party as a function of the past annual compensation;
the computer system automatically determining a maximum projected benefit of the party at each of a plurality of assumed retirement ages;
the computer system automatically calculating a projected accumulation at each of the plurality of assumed retirement ages as a function of the maximum projected benefit and a predetermined rate of investment return;
the computer system automatically estimating for each of the plurality of assumed retirement ages a level funding normal cost as a function of the projected accumulation at the assumed retirement age to obtain a plurality of estimated level funding normal costs;
the computer system automatically selecting a maximum level funding normal cost from the plurality of estimated level funding normal costs;
the computer system automatically determining a maximum current year benefit accrual of the party at each of the plurality of assumed retirement ages;
the computer system automatically calculating a projected accumulation at each of the plurality of assumed retirement ages as a function of the maximum current year benefit accrual, a predetermined life expectancy and a predetermined rate of investment return;
the computer system automatically estimating for each of the plurality of assumed retirement ages a unit credit normal cost as a function of the projected accumulation to obtain a plurality of estimated unit credit normal costs;
the computer system automatically selecting a maximum unit credit normal cost from the plurality of estimated unit credit normal costs; and
the computer system automatically determining a current year maximum contribution as a higher one of the maximum level funding normal cost and the maximum unit credit normal cost.

17. The method according to claim 16, wherein the average compensation comprises a high average compensation of past annual compensation for three consecutive years.

18. The method according to claim 16, wherein at least one of determining the maximum projected benefit and determining the maximum current year benefit accrual at each assumed retirement age comprises an iterative calculation.

19. The method according to claim 16, further comprising:
displaying through the user interface the current year maximum contribution for the party; and
requesting and receiving through the user interface a target annual contribution from the party;
wherein the computer system automatically structures the defined benefit plan using the target annual contribution.

20. The method according to claim 19, wherein structuring the defined benefit plan comprises the computer system automatically comparing the target annual contribution to at least one of the plurality of estimated level funding normal costs and the plurality of estimated unit credit normal costs to determine an optimal retirement age for the target annual contribution.

21. The method according to claim 16, further comprising:
receiving a revised current year compensation from the party through the user interface; and
the computer system automatically determining a revised current year contribution as a function of the revised current year compensation.

22. The method according to claim 21, further comprising receiving an account value from an asset administrator, wherein the computer system automatically determines a revised current year maximum contribution as a function of the revised current year compensation and the account value.

23. The method according to claim 21, wherein the revised current year compensation comprises an estimate update and the computer system automatically determining a revised estimated current year contribution.

24. The method according to claim 21, wherein the revised current year compensation comprises a final current year compensation.

25. A method of determining a contribution for restructuring a defined benefit plan of a party, the method comprising:
providing a user interface associated with a computer system;
the computer system retrieving from a database information including at least one of an age of the party, years of service and past annual compensation;
the computer system receiving an account value for the defined benefit plan from an asset administrator;
the computer system automatically estimating a maximum level funding normal cost as a function of the information and the account value;
the computer system automatically estimating a maximum unit credit normal cost as a function of the information and the account value; and
the computer system automatically determining a current year maximum contribution as a higher one of the maximum level funding normal cost and the maximum unit credit normal cost.

26. The method according to claim 25, wherein the defined benefit plan is structured in a first business year and restructured in a subsequent business year.

27. The method according to claim 26, further comprising:
the computer system automatically calculating an average compensation of the party as a function of the past annual compensation;
the computer system automatically determining a maximum projected benefit of the party at each of a plurality of assumed retirement ages;
the computer system automatically calculating a projected accumulation at each of the plurality of assumed retirement ages as a function of the maximum projected benefit, a predetermined life expectancy and a predetermined rate of investment return;
the computer system automatically estimating for each of the plurality of assumed retirement ages a level funding normal cost as a function of the projected accumulation at the assumed retirement age and the account value to obtain a plurality of estimated level funding normal costs;
the computer system automatically selecting a maximum level funding normal cost from the plurality of estimated level funding normal costs;
the computer system automatically determining a maximum current year benefit accrual of the party at each of the plurality of assumed retirement ages;
the computer system automatically calculating a projected accumulation at each of the plurality of assumed retirement ages as a function of the maximum current year benefit accrual, a predetermined life expectancy and a predetermined rate of investment return;
the computer system automatically estimating for each of the plurality of assumed retirement ages a unit credit normal cost as a function of the projected accumulation and the account value to obtain a plurality of estimated unit credit normal costs;
the computer system automatically selecting a maximum unit credit normal cost from the plurality of estimated unit credit normal costs; and
the computer system automatically determining a current year maximum contribution as a higher one of the maximum level funding normal cost and the maximum unit credit normal cost.

28. The method according to claim 26, further comprising:
displaying through the user interface the current year maximum contribution for the party; and
requesting and receiving through the user interface at least one target annual contribution from the party; and
automatically determining an optimal retirement age for the at least one target annual contribution.
